(19) United States
(12) Patent Application Publication
(10) Pub. No.: US 2013/0193626 A1
(43) Pub. Date: Aug. 1, 2013

(54) ADJUSTABLE HEIGHT TURNTABLE DEVICE

(71) Applicant: ALPHONSO WOODBURN, Orlando, FL (US)

(72) Inventor: ALPHONSO WOODBURN, Orlando, FL (US)

(21) Appl. No.: 13/362,002

(22) Filed: Jan. 31, 2012

(51) Int. Cl. B05C 13/00

(52) U.S. Cl. 269/58

(57) ABSTRACT

An adjustable height turntable device includes a base unit having a mechanical pump and a release actuator, the base unit acting to position a telescoping shaft in a vertical orientation. An elongated, generally planar cake tray is removably secured to the top of the telescoping shaft, and a pneumatic lifting system positioned within the base unit acts to raise and lower the height of the cake tray.

### TECHNICAL FIELD

The present invention relates generally to food preparation devices, and more particularly to a turntable having an adjustable height for preparing confections and the like.

### BACKGROUND

The statements in this section merely provide background information related to the present disclosure and may not constitute prior art.

When preparing cakes and other such confections, it is necessary for the baker to be able to view and access all of the cake surfaces in order to ensure the frosting, fondant and/or decorative elements such as sugar work and piping are correctly positioned.

There are many known turntable devices having a fixed stand and a rotating tray onto which the cake sits during a decorating procedure. However, these stands do not allow a user to adjust the height of the cake, which often results in back and neck problems. To this end, it is common for users to attempt to stack boxes and other such objects beneath the turntables in order to raise the height to an acceptable level. Unfortunately, this stacking often leads to disaster as the boxes can become crushed under the weight of the turntable, or the turntable itself can inadvertently fall off of the boxes during operation.

There have been previous devices directed towards adjustable height turntables. One such example described in U.S. Pat. No. 7,975,643, utilizes a series of tubes of varying lengths which can be removably installed between a cake tray and a base. However, this device requires that a user pre-assemble the stand before use, which does not allow a user to adjust the height of the cake tray while in operation. As such, a user can not adjust the height of the cake tray as additional layers and/or decorations are added, which can contribute to back and neck pain.

Accordingly, there remains a need for an adjustable height turntable device capable of allowing a user to quickly and easily adjust the height of a cake tray during operation that does not suffer from the drawbacks of the devices described above.

### SUMMARY OF THE INVENTION

The present invention is directed to an adjustable height turntable device. One embodiment of the present invention can include a base unit having a mechanical pump and a release actuator that positions a telescoping shaft in a vertical orientation. An elongated, generally planar cake tray can be secured to the top of the telescoping shaft, and a pneumatic lifting system positioned within the base unit can act to raise and lower the height of the cake tray.

Another embodiment of the present invention can further include an electric pump configured to automatically raise and lower the height of the cake tray.

Yet another embodiment of the present invention can include a mechanical motor configured to raise and lower the cake tray, in addition to a foot operated switch and a display holder.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a front view of an adjustable height turntable device that is useful for understanding the inventive concepts disclosed herein.

FIG. 2 is a cutout view of a pneumatic system for use with the adjustable height turntable device in accordance with one embodiment of the invention.

FIG. 3 is a perspective view of the adjustable height turntable device in accordance with another embodiment of the invention.

FIG. 4 is a perspective view of the adjustable height turntable device in accordance with an alternate embodiment of the invention.

FIG. 5 is a perspective view of the adjustable height turntable device in accordance with another alternate embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

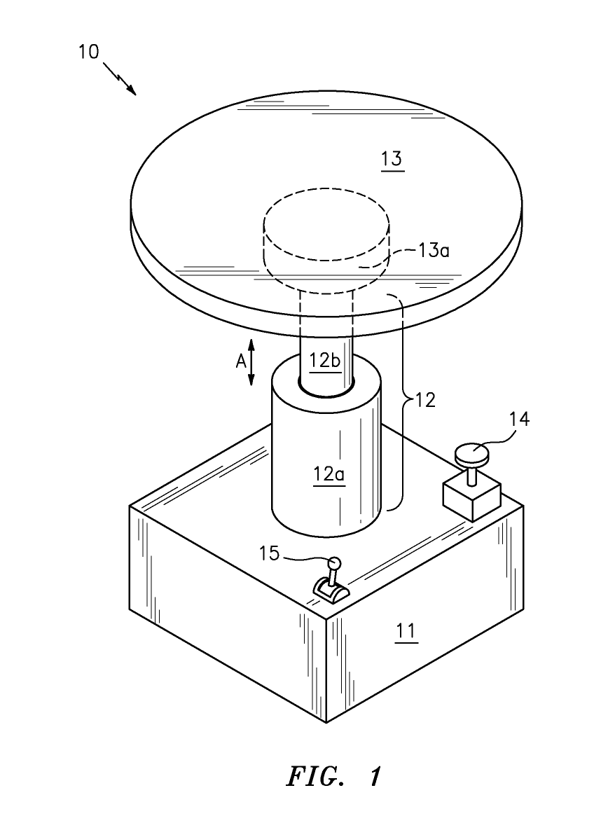

For purposes of this description, the terms “upper,” “bottom,” “right,” “left,” “front,” “vertical,” “horizontal,” and derivatives thereof shall relate to the invention as oriented in FIG. 1.

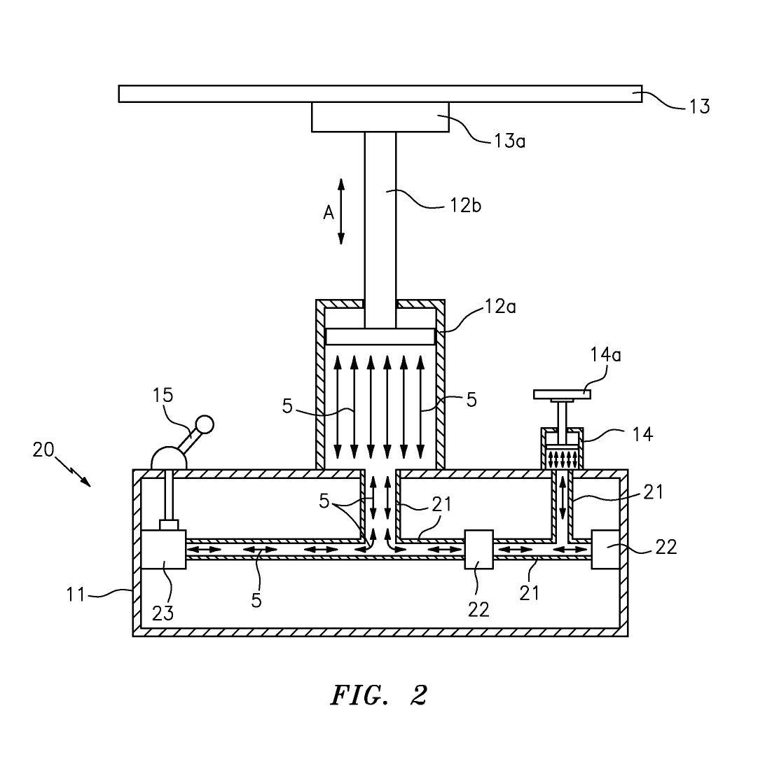

FIGS. 1 and 2 illustrate one embodiment of an adjustable height turntable device 10 that is useful for understanding the inventive concepts disclosed herein. As shown, the device 10 can include a base unit 11 containing a pneumatic system 20, a telescoping shaft 12 and a cake tray 13.

The base unit 11 can act as a stand for positioning the device in a desired location. In one embodiment, the base unit 11 can include a generally rectangular shape having a top surface, a bottom surface, a plurality of side surfaces, and a hollow interior space. In one preferred embodiment, the base unit 11 will be constructed from a sturdy waterproof and contagion resistant material such as stainless steel, for example, however any number of other materials and shapes are also contemplated. Additionally, the base unit can be manufactured in varying dimensions and weights to avoid tipping when the device is in use and has become top heavy from the weight of the cake.

A pump 14 and release valve actuator 15 can be secured to the base unit 11 for controlling the operation of the pneumatic system 20 (See FIG. 2) contained within the cavernous interior of the base unit.

The cake tray 13 can act as a platform for positioning, displaying, and working on confections such as cakes, pastries, pies and the like. In one preferred embodiment, the cake tray 13 can also be constructed from a sturdy waterproof and contagion resistant material such as stainless steel or titanium, for example. The cake tray 13 can be removably and rotatably attached to the upper end of the telescoping shaft 12b via a conventional shaft collar 13a disposed on the bottom side of the cake tray in order to allow the cake tray 13 to rotate while in use. Such a feature can allow the device to accommodate any number of interchangeable cake trays having varying shapes and sizes.

The telescoping shaft 12 can act to raise and lower the height of the cake tray 13 when commanded by a user. In one embodiment, the telescoping shaft 12 can include a hollow outer rod 12a secured to the top of the base unit 11, and a sliding rod 12b configured to extend from and retract into the outer rod 12a (see arrow A). The telescoping shaft 12 can preferably include a circular cross section and can be constructed from a hardened yet lightweight material such as metal tubing or hardened plastic, for instance, each having extremely good tensile strength. Of course, other shapes and materials are also contemplated.

FIG. 2 illustrates one embodiment of a pneumatic system 20 which can be positioned within the cavernous interior of the base unit 11. As shown, the system 20 can include one or more hollow tubular air channels 21 in communication with the pump 14, shaft 12 and a release valve 23.

The pump 14, according to one embodiment can comprise a conventional mechanical air pump having a handle 14a configured to force air 5 into the air channel 21. As shown, the air 5 can travel through one or more check valves 22 until reaching the outer rod 12a where the forced air can act to raise and lower the sliding rod 12b in a conventional manner. The air channel 21 can also be connected to a release valve 23 configured to remove the forced air 5 from the system when operated by the valve actuator 15 (such as a switch or rod, for example).

In operation, a user can act to raise and lower the height of the cake tray 13 by pumping air into the system 20 via the pump 14 and removing air from the system via the valve 23, respectively. Moreover, the height of the cake tray 13 can be quickly and easily adjusted to suit the immediate needs of the user while confections are present on the tray.

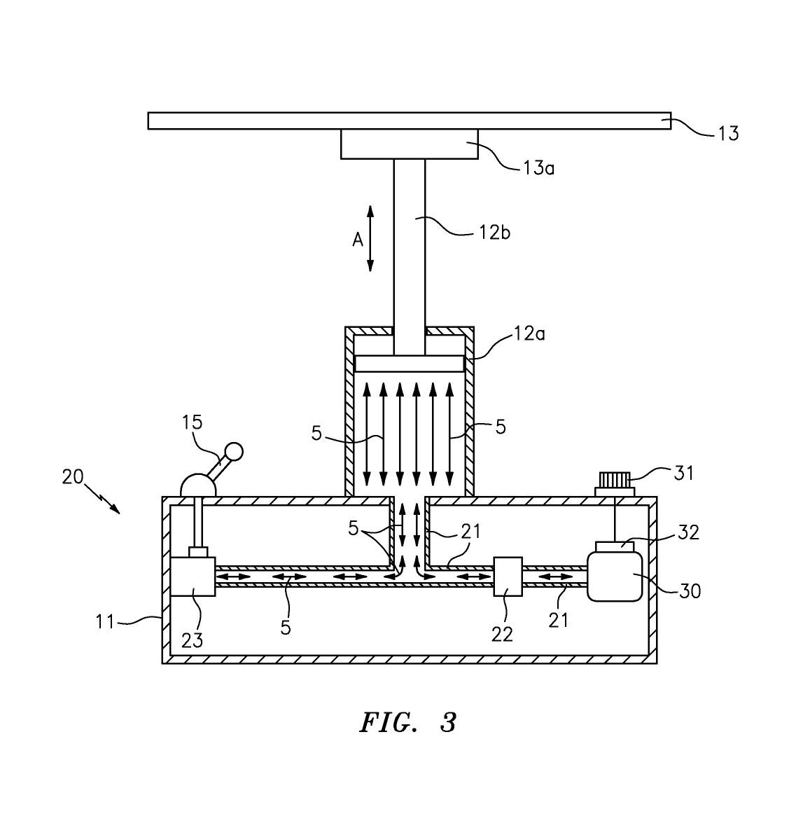

Although described above as including a mechanical pump, the invention is not so limited. For example, FIG. 3 illustrates an alternate embodiment of the pneumatic system 20 that further includes an electric pump 30 having a control switch 31 and a power source 32 configured to operate the device in an automated fashion. In this embodiment, pump handle 14a can act as a switch to activate the electric pump. As described herein, the power source 32 can include one or more DC batteries capable of providing the necessary power requirements to the system 30, or can include a common A/C electrical power transformer capable of allowing the device 10 to be powered from a standard electrical outlet (not illustrated).

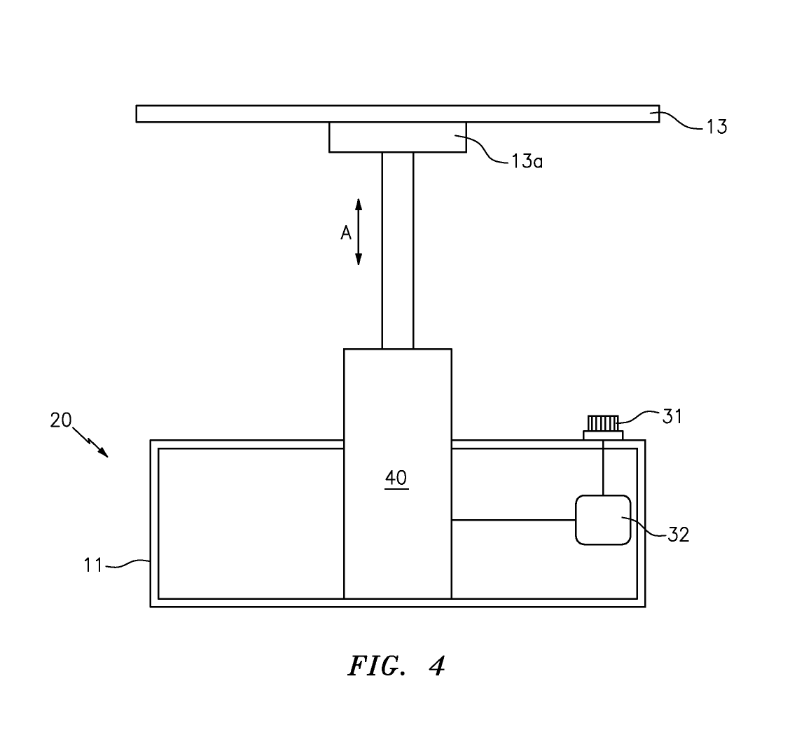

Although described above as including a pneumatic lifting system, one of skill in the art will recognize that any number of other known components can be utilized to raise and lower the telescoping shaft 12. For example, FIG. 4 illustrates an alternate embodiment of an adjustable height turntable device 10 wherein the telescoping shaft 12 is replaced with a linear actuated motor 40 powered by a power source 32 and controlled by one or more control switches 31.

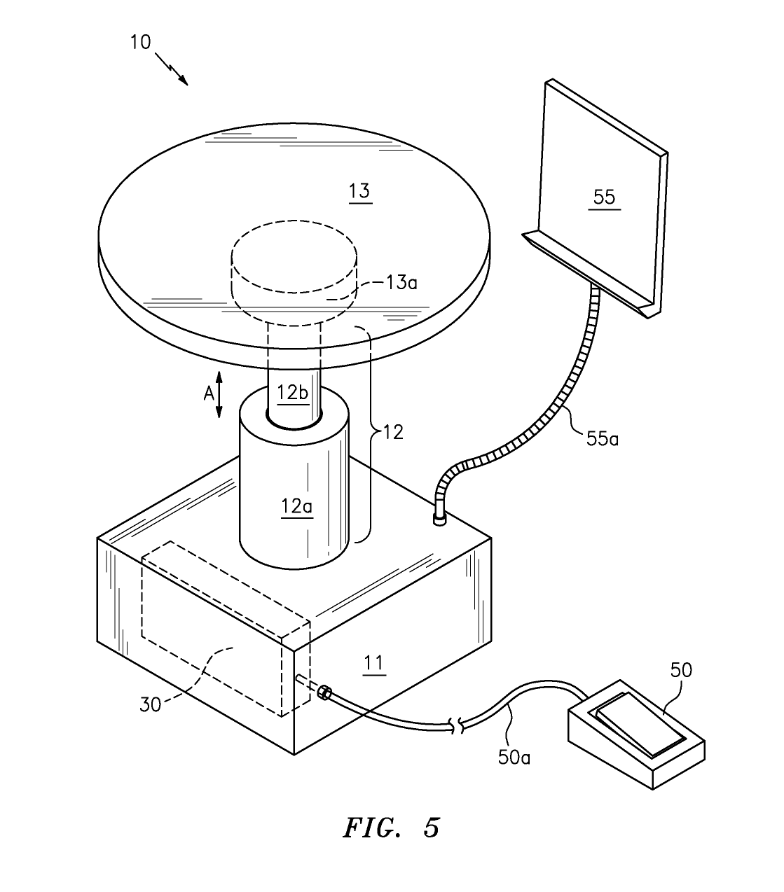

FIG. 5 illustrates another embodiment of the adjustable height turntable device 10 that includes a foot operated switch 50 and an optional document/recipe holder 55. As described herein, the foot switch 50 can be attached to the base 10 via a cord 50a, in order to allow a user to raise and lower the height of the telescoping shaft 12 via the electric pump 30 and/or linear actuated motor 40. As shown, the optional document/recipe holder 55 can include a flexible stand 55a configured to position a document or a picture near to the cake tray 13 in order to provide quick and easy reference by the user.

Although not specifically illustrated, the above described embodiment can equally be utilized with the pneumatic system 20 by substituting the foot switch 50 and cord 50a with a mechanical foot pump and flexible tube that is connected to one of the hollow air tubes 21 in a conventional manner. Accordingly, the illustrated embodiments are not to be construed as limiting upon the invention.

As described herein, one or more elements of the adjustable height turntable device 10 can be secured together utilizing any number of known attachment means such as, for example, screws, glue, compression fittings and welds, among others. Moreover, although the above embodiments have been described as including separate individual elements of varying materials, one of skill in the art will recognize that one or more individual elements such as the base 11, tray 13 and/or telescoping shaft 12, including all sub components, can be made from identical or different materials. However, in one preferred embodiment, each of the above described components can be constructed from thin sheets of lightweight stainless steel. Of course other materials such as plastic, PVC and composite materials are also contemplated.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An adjustable height turntable device, comprising:
a telescoping shaft having a first end and a second end;
a base unit for supporting the telescoping shaft in an upright position, said base unit having a top portion, a bottom portion, a plurality of side portions and a cavernous interior portion,
wherein a portion of the first end of the telescoping shaft is secured vertically to the top portion of the base unit;
an elongated generally planar cake tray having a top surface and a bottom surface;
a shaft connector secured to the bottom surface of the cake tray, said shaft connector being configured to secure the cake tray to the second end of the telescoping shaft; and
a pneumatic lifting system configured to raise and lower a height of the cake tray, said system including
a plurality of hollow tubular air channels, said channels being in communication with a pump, a release valve and the telescoping shaft,
said pump being configured to deposit air into at least one of the plurality of air channels,
said release valve being configured to remove air from the at least one of the plurality of air channels, and
one or more check valves secured to the at least one of the air channels, each of said check valves being configured to control a flow of air within the system.

2. The turntable device of claim 1, wherein said cake tray is configured to spin when secured to the shaft.

3. The turntable device of claim 1, wherein said shaft connector is configured to removably secure the shaft to the cake tray.

4. The turntable device of claim 1, wherein the cake tray is configured to rotate when secured to the shaft.

5. The turntable device of claim 1, wherein said pump includes a mechanical push pump secured a portion of the base unit.

6. The turntable device of claim 1, wherein said pump includes an electric air pump.

7. The turntable device of claim 6, further comprising:
a control switch secured to the base unit, said control switch being configured to operate the electric air pump.

8. The turntable device of claim 6, further comprising:
a tethered foot switch configured to allow a user to operate the electric air pump utilizing a foot.

9. The turntable device of claim 1, wherein said pump includes a mechanical foot pump connected to at least one of the air channels via a flexible hose, said foot pump being configured to allow a user to adjust the height of the cake tray using a foot.

10. An adjustable height turntable device, comprising:
a linear motor that includes a shaft having a termination point;
a base unit for supporting the linear motor in an upright position, said base unit having a top portion, a bottom portion, a plurality of side portions and a cavernous interior portion,
wherein the shaft protrudes vertically from the top portion of the base unit;
an elongated generally planar cake tray having a top surface and a bottom surface;
a shaft connector secured to the bottom surface of the cake tray, said shaft connector being configured to secure the cake tray to the termination point of the shaft;
a control switch configured to raise and lower a height of the cake tray by activating the linear motor; and
a power source configured to power the device.

11. The turntable device of claim 10, wherein said control switch is secured to the base unit.

12. The turntable device of claim 10, wherein said control switch comprises:
a tethered foot switch configured to allow a user to operate the linear motor utilizing a foot.
